(19) United States
(12) Patent Application Publication
(10) Pub. No.: US 2006/0049164 A1
(43) Pub. Date: Mar. 9, 2006

(54) Electric countertop cooking grill with removablel cooking plates

(76) Inventor: Benjamin Bryan, New York, NY (US)

Correspondence Address: John Carr;Zuber & Taillieu, Ste 900, 9595 Wilshire Blvd., Beverly Hills, CA, 90212, US

(21) Appl. No.: 10/930,244

(22) Filed: Aug. 31, 2004

(51) Int. Cl. F24C 7/10; F27D 11/00

(52) U.S. Cl. 219/386

(57) ABSTRACT

An electrically operated countertop grill that includes an upper housing with a removable upper cooking plate disposed therein, and a lower housing with a removable lower cooking plate disposed therein. The lower housing defines a horizontal plane, and the lower cooking plate is disposed at an angle relative to the horizontal plane. The upper cooking plate is movable about a pivot axis relative to the lower cooking plate to a closed position to form a cooking chamber for cooking foodstuffs that substantially restrains the escape of vapor therefrom. At least one heating element is disposed within the lower housing for supplying heat to the lower cooking plate to provide heat to the cooking chamber, and at least one heating element is disposed within the upper housing for supplying heat to the upper cooking plate to provide heat to the cooking chamber. The lower cooking plate inclines gradually and downwardly from a proximate position relative to the pivot axis toward a distal position relative to the pivot axis such that liquid byproducts emitted by foodstuffs during cooking flow downwardly on the lower cooking plate toward a liquid byproducts collection reservoir disposed at the distal position. In one embodiment of the invention, a clasp and clip system holds the lower cooking plate to the lower housing, and the upper cooking plate to the upper housing.

### FIELD OF THE INVENTION

The present invention relates to an improved electric countertop contact grill for cooking meats, fish, poultry, and other foodstuffs, and more particularly to an electric countertop contact grill having removable cooling plates.

### PRIOR ART

Indoor, electrically operated countertop contact grills have grown substantially in popularity among the consuming public and many models are commercially available through retail outlets. These countertop contact grills offer a convenient and safe alternative to a traditional barbeque and, as their popularity continues to grow, there is a continuing need to provide electric countertop contact grills that are attractive, safe, and convenient to use.

U.S. Pat. No. 5,606,905 discloses an electric countertop contact grill having an upper housing and a lower housing hinged together in a clamshell arrangement. The lower housing typically bears feet or pads for supporting the grill on a countertop, and the upper housing is pivotally mounted or hinged to the lower housing for rotation about a horizontal pivot axis such that the upper housing may be pivoted into an opened or closed position. The lower housing includes an upwardly facing cooking surface and the upper housing includes a downwardly facing cooking surface such that when the upper housing is pivoted into the opened position both surfaces are exposed and when the upper housing is pivoted into the closed position the downwardly facing cooking surface of the upper housing will come into close proximity to and/or contact with the upwardly facing cooking surface of the lower housing.

In many embodiments, the cooking surfaces of the lower and upper housings may be flat, use of flat griddle-like cooking surfaces are useful for cooking foods such as potatoes or pancakes. Alternatively, the cooking surfaces may be formed with channels or “ribs”. Formation of ribs allows for easier and more efficient cooking of foods like meats or vegetables. A ribbed surface more closely approximates an outdoor meat grilling or barbeque arrangement, and the channels between the ribs can carry away grease and fats that drain from meats while cooking.

When using a conventional electric countertop contact grill, the user places foodstuffs on the upwardly facing cooking surface of the lower housing and then closes the upper housing down upon it, such that the foodstuff are then held between the downwardly facing cooking surface of the upper housing and the upwardly facing cooking surface of the lower housing, thereby allowing the foodstuffs to cook on both sides simultaneously and speeding up the grilling or cooking process.

In many countertop contact grills, the lower housing is configured with a downwardly sloping surface such that upwardly facing cooking surface of the lower housing slopes downward and away from a proximal location near the pivot axis to a distal location that is considered to be at the front of the grill. Liquid, fat and small food particle byproducts of the cooking process (hereinafter “liquid byproducts”) will then slide or flow down the sloping upwardly facing cooking surface of the lower housing. These liquid byproducts may flow into a collection reservoir or vessel at the front of the grill, which may constitute a reservoir or recess formed in the lower housing or which may be a individual vessel, separate and apart from the lower housing. For example, many electric countertop contact grills commonly provide a liquid byproduct outlet at the front of the grill and a liquid byproduct collection tray which may placed underneath the liquid byproduct outlet, as disclosed in U.S. Pat. No. 6,016,741. Such liquid byproduct collection trays are easily cleaned because they are separate from the countertop contact grill and are easily separable from the rest of the grill unit. More particularly, such liquid byproduct collection trays can be easily washed under a faucet, soaked in a sink, or even placed in a dishwasher.

Unfortunately, conventional electric countertop contact grills are not entirely satisfactory due to the difficulty involved in cleaning such grills. The cooking surfaces of conventional electric countertop contact grills disclosed in the prior art are not separate from or easily separable from the upper and lower housings. Hence, unlike the liquid byproduct collection tray disclosed in U.S. Pat. No. 6,016,741, such cooking surfaces must be washed along with the entire grill unit, which cannot be easily washed under a faucet, soaked in a sink, or placed in a dishwasher. It is particularly troublesome to clean residue left in the channels between adjacent ribs on ribbed cooking plates found on many electric countertop contact grills.

Additionally, such electric countertop contact grills are not entirely satisfactory due to the inability to easily vary cooking surfaces. As explained earlier, some cooking surfaces are more useful than others for cooking particular types of foods. For instance, flat griddle-like cooking surfaces are useful for cooking foods such as potatoes or pancakes, while ribbed cooking surfaces are better for cooking foods like meats because the ribbed surface allows channels between the ribs to carry away grease and fats that drain from meats while cooking.

### OBJECT OF THE INVENTION

It would therefore be advantageous to have an electric countertop contact grill that incorporates all of the features of electric countertop contact grill devices disclosed in the prior art, yet allows for greater ease in cleaning of the cooking surfaces. It would further be advantageous to have an electric countertop contact grill that incorporates all of the features of the electric countertop contact grill disclosed in the prior art, yet allows for easy replacement and variation of the cooking surfaces. Further objects and advantages of the invention will become apparent from a consideration of the drawings and ensuing description.

### SUMMARY OF THE INVENTION

The invention provides an improved electric countertop contact grill device that obviates the disadvantages and limitations of conventional electrically operated countertop contact grills as noted above by providing for removable cooking plates coupled to the upper and lower housings. More particularly, the invention provides an improved electric countertop contact grill device with cooking plates that may be easily removed and cleaned. Furthermore, the invention also provides an improved electric countertop contact grill device that allows for easy variation of its cooking surfaces by easy removal and substitution of various cooking plates having different cooking surfaces.

In accordance with the foregoing objects, the present invention provides a grill that includes an upper housing with a removable upper cooking plate disposed thereon, and a lower housing with a removable lower cooking plate disposed thereon. The upper housing is preferably pivotally mounted or hinged to the lower housing for rotation about a horizontal pivot axis such that the upper housing may be pivoted into an opened or closed position relative to the lower housing.

The lower housing includes a removable lower cooking plate having an upwardly facing cooking surface which defines a horizontal plane. The lower housing is preferably disposed at an angle relative to the horizontal plane such that the removable lower cooking plate slopes downward and away from a proximal location near the pivot axis to a distal location that is considered to be at the front of the grill. The upwardly facing cooking surface of the lower cooking plate is preferably formed of or coated with a non-stick material such as Teflon.

As explained, the upper housing also includes a removable upper cooking plate having a downwardly facing cooking surface. The downwardly facing cooking surface of the upper cooking plate is preferably formed of or coated with a non-stick material such as Teflon. The upper housing is movable about a pivot axis relative to the lower housing into a closed position bringing the downwardly facing cooking surface of the upper cooking plate and the upwardly facing cooking surface of the lower cooking plate into close proximity and/or contact and thereby forming a cooking chamber for cooking foodstuffs that substantially restrains the escape of vapor therefrom.

At least one heating element is disposed within said lower housing below or under the lower cooking plate, for supplying heat to said lower cooking plate to provide heat to said cooking chamber. Additionally, at least one heating element is disposed within said upper housing above or over the upper cooking plate for supplying heat to said upper cooking plate to provide heat to said cooking chamber.

In one embodiment of the invention, a clasp and clip system holds said lower cooking plate to said lower housing, and said upper cooking plate to said upper housing. Said clasp and clip system comprises one or more clips disposed on the end of said lower housing proximate to said pivot axis, one or more catches disposed within the end of said lower housing distal to said pivot axis, one or more catches disposed on the non-cooking or bottom surface of the lower cooking plate at an end proximate to said pivot axis, one or more clasps disposed on the non-cooking or bottom surface of said lower cooking plate at an end distal to said pivot axis, one or more clips disposed on the end of said upper housing distal to said pivot axis, one or more catches disposed on end of said upper housing proximate to said pivot axis, one or more catches disposed on the non-cooking or bottom surface of said upper cooking plate at an end distal to said pivot axis, and one or more clasps disposed on the non-cooking or bottom surface of said upper cooking plate at an end proximate to said pivot axis, wherein said lower cooking plate when fastened to said lower housing is fastened to said lower housing by said one or more clips and said one or more catches of said lower housing, and said upper cooking plate when fastened to said upper housing is fastened to said upper housing by said one or more clips and said one or more catches of said upper housing.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of an electric countertop contact grill constructed in accordance with a preferred embodiment of the invention;

FIG. 2 is another perspective view of an electric countertop contact grill in an open position, in accordance with a preferred embodiment of the present invention;

FIG. 3 is another perspective view of the grill in an open position with the cooking plates removed;

FIG. 4A is a perspective view of the removable lower cooking plate which illustrates the upwardly facing cooking surface;

FIG. 4B is a perspective view of the removable lower cooking plate which illustrates the non-cooking bottom side of the lower cooking plate;

FIG. 5A is a fragmentary perspective view of one of the catches of the lower housing in accordance with a preferred embodiment of the present invention;

FIG. 5B is a fragmentary perspective view of one of the clasps located on the non-cooking bottom side of the lower cooking plate;

FIG. 5C is a cross-sectional view of the clasp of FIG. 5B juxtaposed over the catch of FIG. 5A;

FIG. 5D is a cross-sectional view of the clasp of FIG. 5C secured within the catch of FIG. 5C;

FIG. 6A is a fragmentary perspective view of one of the proximate clips of the lower housing in accordance with a preferred embodiment of the present invention;

FIG. 6B is a fragmentary perspective view of one of the proximate catches of the removable lower cooking plate;

FIG. 6C is a cross-sectional view of the clip of FIG. 6A when displaced by the application of a normal force on the clip;

FIG. 6D is a cross-sectional view of the clip of FIG. 6A against the catch of FIG. 6B such that the clip is secured by the catch;

FIG. 7A is a perspective view of an alternate embodiment of a proximate clip of the lower housing;

FIG. 7B is a close-up view of the alternate embodiment of the clip in 7A which illustrates the reverse tension springs of the clip;

FIG. 7C is a close-up view of the clip of FIG. 7A when displaced by the application of a normal force on the clip;

FIG. 7D is a cross-sectional view of the clip of FIG. 7A against the catch of FIG. 6B such that the clip is secured by the catch;

FIG. 8A is a fragmentary perspective view of one of the catches located within the upper housing;

FIG. 8B is a fragmentary perspective view one of the clasps located on the non-cooking bottom side of the removable upper cooking plate;

FIG. 8C is a cross-sectional view of the clasp of FIG. 8B juxtaposed beneath the catch of FIG. 8A;

FIG. 8D is a cross-sectional view of the clasp of FIG. 8C secured within the catch of FIG. 8C;

FIG. 9A is a fragmentary perspective view of one of the clips of the upper housing;

FIG. 9B is a fragmentary perspective view of one of the catches disposed within the removable upper cooking plate;

FIG. 9C is a cross-sectional view of the clip of FIG. 9A displaced by the application of a normal force on the clip;

FIG. 9D is a cross-sectional view of the clip of FIG. 9C engaged within the catch of FIG. 9B such that the clip is secured by the catch;

### DETAILED DESCRIPTION OF PREFERRED EMBODIMENTS

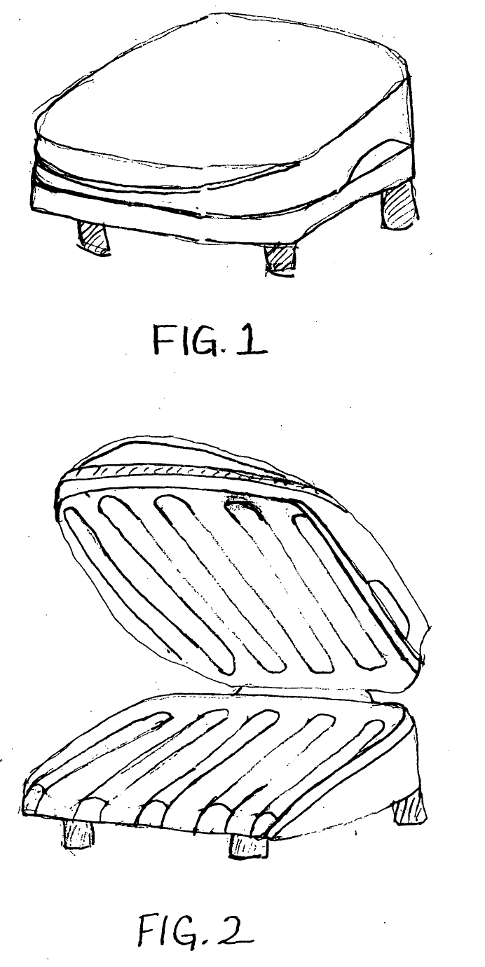

FIG. 1 is a perspective view of a first preferred embodiment of the electrically operated countertop, contact grill of the present invention. FIG. 1 illustrates a perspective view of the grill in a closed position. FIG. 2 illustrates a perspective view of a first preferred embodiment of the grill in an open position. As shown in both FIG. 1 and FIG. 2, the electrically operating countertop, contact grill of the present invention includes a lower housing 10 and an upper housing 80 pivotally coupled to the lower housing. The lower housing 10 includes a removable lower cooking plate 20 having an upwardly facing cooking surface and the upper housing includes a removable upper cooling plate 90 having a downwardly facing cooking surface.

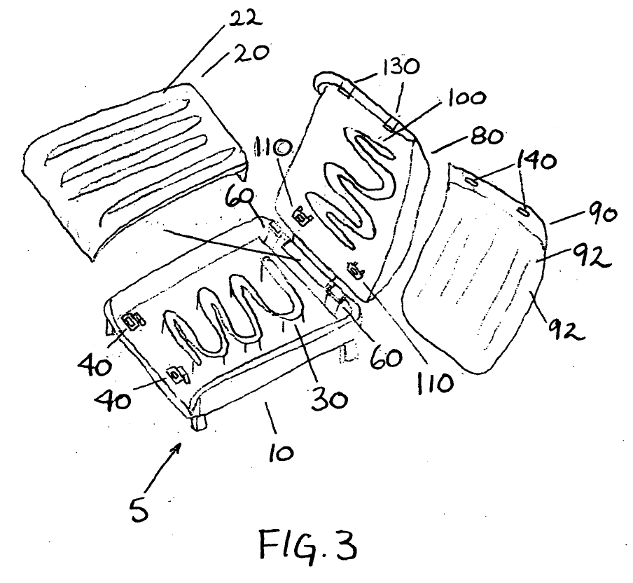

FIG. 3 illustrates a preferred embodiment with the lower cooking plate 20 removed from the lower housing 10, and the upper cooking plate 90 removed from the upper housing 80. Referring to FIG. 3, the preferred embodiment further includes at least one lower heating element 10 housed within the lower housing 10 and designed to provide heat to the lower cooking plate 20 when the lower cooking plate is coupled to the lower housing 10. The grill further includes at least one upper heating element 101 housed within the upper housing 80 and designed to provide heat to the upper cooking plate 90 when the upper cooking plate is coupled to the upper housing 80.

Preferably, the upper housing 80 is pivotally mounted to the lower housing 10 by connecting unit 75. The upper housing 80 is pivotally mounted to the lower housing 10 for rotation about a horizontal pivot axis such that the upper housing may be pivoted into an opened or closed position relative to the lower housing.

In the preferred embodiment of FIG. 3, the upper 90 and lower 20 cooking plates are coupled to the upper and lower housings, respectively, through the use of a clasp/catch arrangement on one end and a clip/catch arrangement on another end. It is understood that the position, order and arrangement of each clasp/catch and clip/catch arrangement may be altered and or varied in order to still achieve the objects of the invention. As shown in FIG. 3 a preferred embodiment includes one or more clips 60 disposed within a first end of said lower housing, proximate to said pivot axis, and one or more catches 40 disposed within a second end of said lower housing, distal to said pivot axis. This embodiment further includes one or more clips 130 disposed within a first end of said upper housing, distal to said pivot axis, and one or more catches 110 disposed within a second end of said upper housing, proximate to said pivot axis.

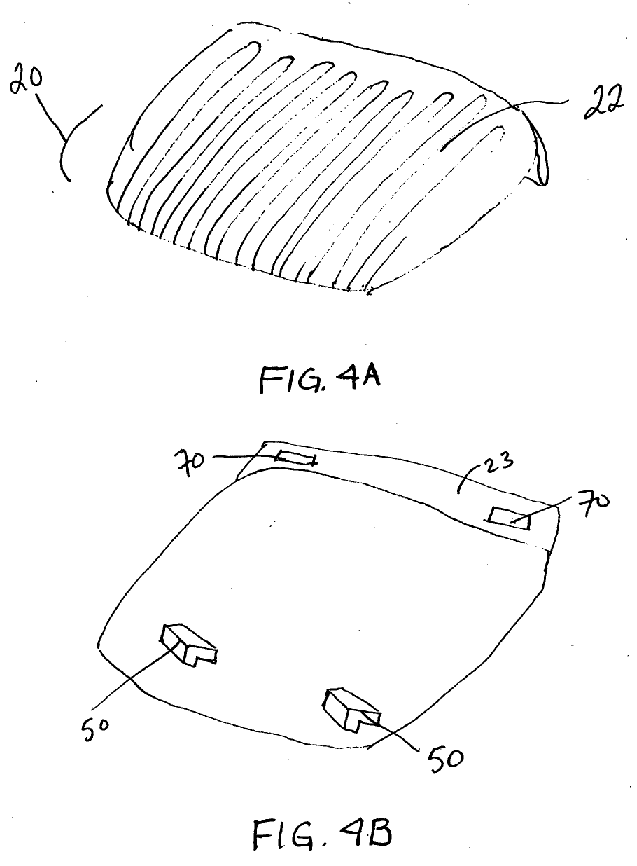

FIG. 4A shows a top or cooking surface view of a first preferred embodiment of the lower cooking plate 20 and FIG. 4B shows a bottom or non-cooking surface view of a first preferred embodiment of the lower cooking plate 20. As show in FIGS. 4A-B, the lower cooking plate has an upwardly facing cooking surface 22. This upwardly facing cooking surface 22 is preferably formed of or coated with a non-stick surface such as Teflon. The lower cooking plate 20 also has one or more clasps 50 positioned at a first end of the lower cooking plate along the non-cooking bottom surface of the cooking plate, as illustrated in FIG. 4. A second end of the lower cooking plate preferably includes a lipped edge 23 which extends outwardly away from the non-cooking bottom surface of the cooking plate. The lipped edge 23 preferably includes one or more catches 70.

As explained further hereinafter, the one or more clasps 50 positioned along the non-cooking or bottom surface 22 of the lower cooking plate 20 are designed to engage with the one or more catches 40 disposed within the second end of said lower housing, distal to said pivot axis, when said lower cooking plate is coupled to said lower housing. Likewise, the one or more vertical catches 70 in the lipped edge of the lower cooking plate are designed to engage with the one or more clips 60 disposed within the first end of said lower housing, proximate to said pivot axis, when said lower cooking plate is coupled to said lower housing.

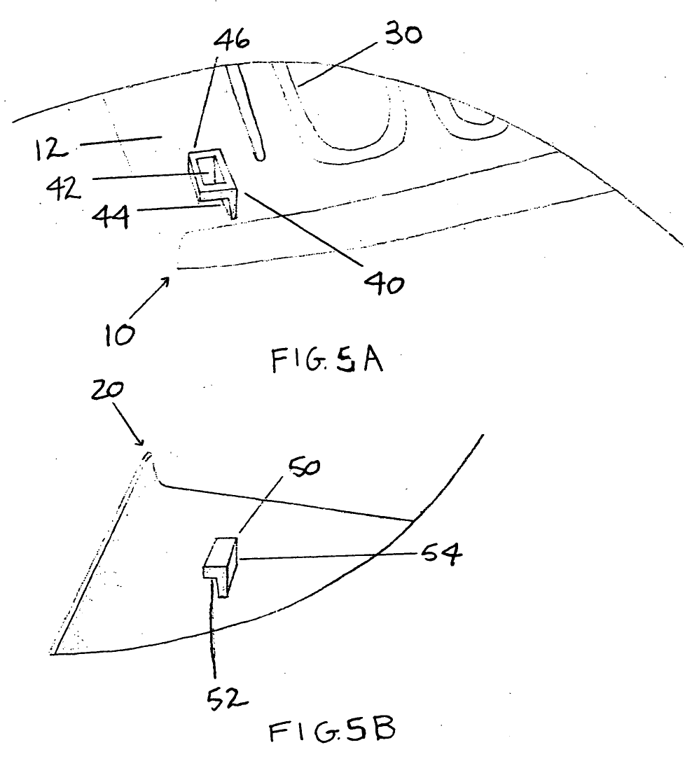

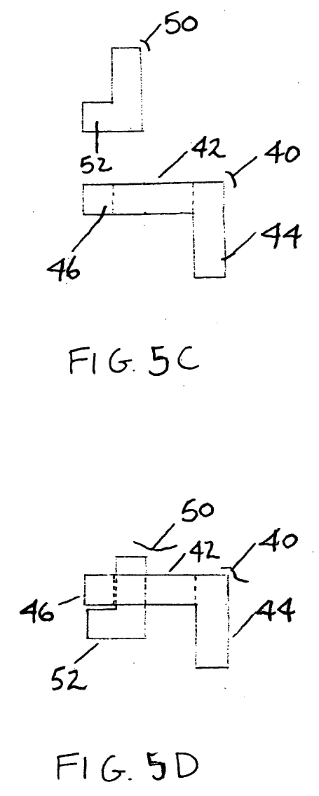

FIG. 5A is a fragmentary perspective view of one of the corners of the lower housing 10 distal to the connecting unit 75. Referring to FIG. 5A, catch 40 is coupled to the inside of the lower housing and includes an aperture 42 and a base 44. Catch 40 may be comprised and/or formed from any number of different metals or practical equivalents, including steel, iron, copper, brass, or any combination thereof. FIG. 5B is a fragmentary perspective view of one of the corners of non-cooking or bottom surface of the lower cooking plate 20 distal to connecting unit 75. Referring to FIG. 5B, clasp 50 is coupled to the non-cooking or bottom surface of lower cooking plate 20 and includes a protrusion 52 and a base 54. Clasp 50 may be comprised and/or formed from any number of different metals or practical equivalents, including steel, copper, brass, or any combination thereof.

FIG. 5C is a cross-sectional view of clasp 50 juxtaposed over catch 40. Referring to FIG. 5C when the lower cooking plate is coupled to the lower housing, catch 40 accepts the protrusion 52 of clasp 50 through the aperture 42 of catch 40, such that protrusion 52 is secured within the aperture 42, thereby engaging and securing clasp 50 within catch 40. FIG. 4D is a cross-sectional view of clasp 50 secured within catch 40.

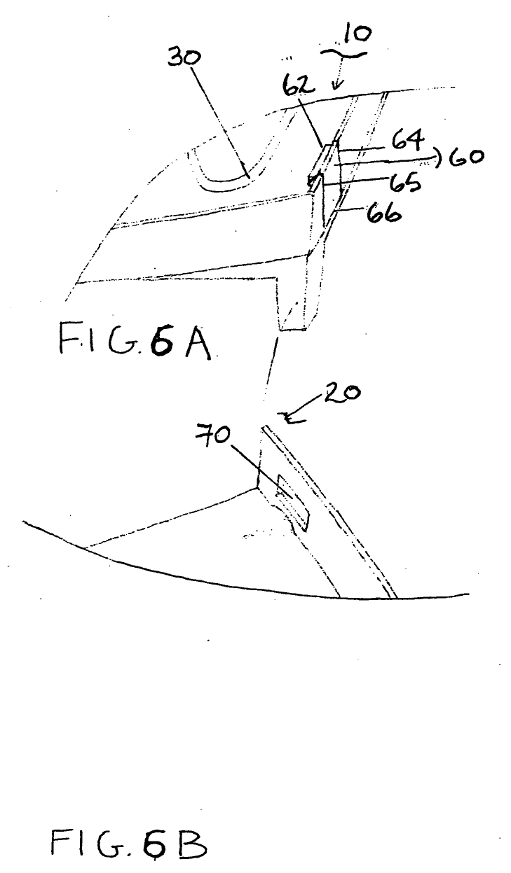

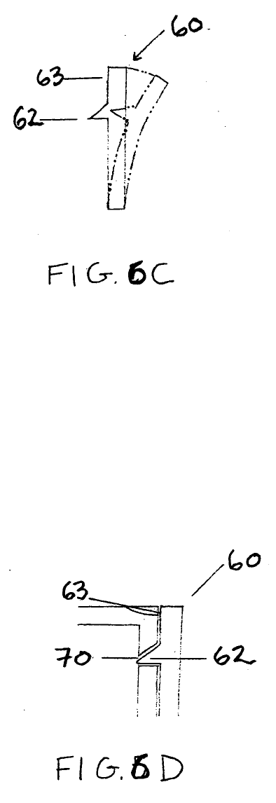

FIG. 6A is a fragmentary perspective view of one of the corners of lower housing 10 proximate to connecting unit 75. Referring to FIG. 6A, clip 60 includes protrusion 62. As shown, protrusion 62 is rectangular in shape, although it is understood it may have any alternate shape such square, trapezoidal and or retangular. Referring to FIG. 6A, the bottom 66 of clip 60 is smooth and continuous (i.e. flushed) with the back side of lower housing 10 but separated vertically from the outer shell of lower housing 10 at separation 64 and separation 65. Clip 60 may be comprised of plastic or other materials possessing a high elastic limit or yield point, as those terms “elastic limit” and “yield point” are commonly known among those skilled in the art.

FIG. 6B is a fragmentary perspective view of one of the corners of lipped edge of lower cooking plate 20 proximate to connecting unit 75. Referring to FIG. 6B relative to FIG. 3, lower cooking plate 20 has been flipped upside down such that the non-cooking or bottom surface of lower cooking plate 20 (i.e.: the bottom side of lower cooking plate 20 that does not come in contact with food during cooking) is revealed. Referring to FIG. 6B, catch 70 is preferably formed within the lipped edge of lower cooking plate 20 and is comprised of an aperture for reception of protrusion 62.

FIG. 6C is a cross-sectional view of clip 60. As shown in FIG. 6C, clip 60 may be displaced by the application of a normal force at 63, as applied by a finger or thumb of the grill user, allowing juxtaposition of catch 70 against clip 60 such that protrusion 62 is positioned for entry into catch 70. Subsequent removal of the normal force at 63 allows clip 60 to snap back to its default position such that protrusion 62 is secured within catch 70, as shown in FIG. 6D. In the preferred embodiment, the length of lower cooking plate 20 that lies between clasps 50 and catches 70 is precisely long enough such that when protrusions 62 are secured within catches 70, the lower cooking plate is secured to the lower housing and there is no unwanted shifting of lower cooking plate 20 during cooking.

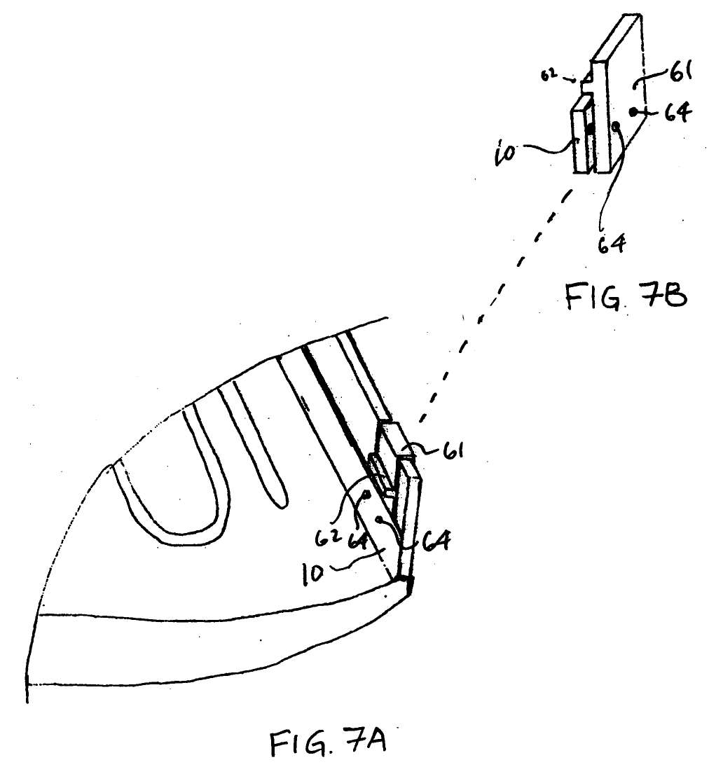

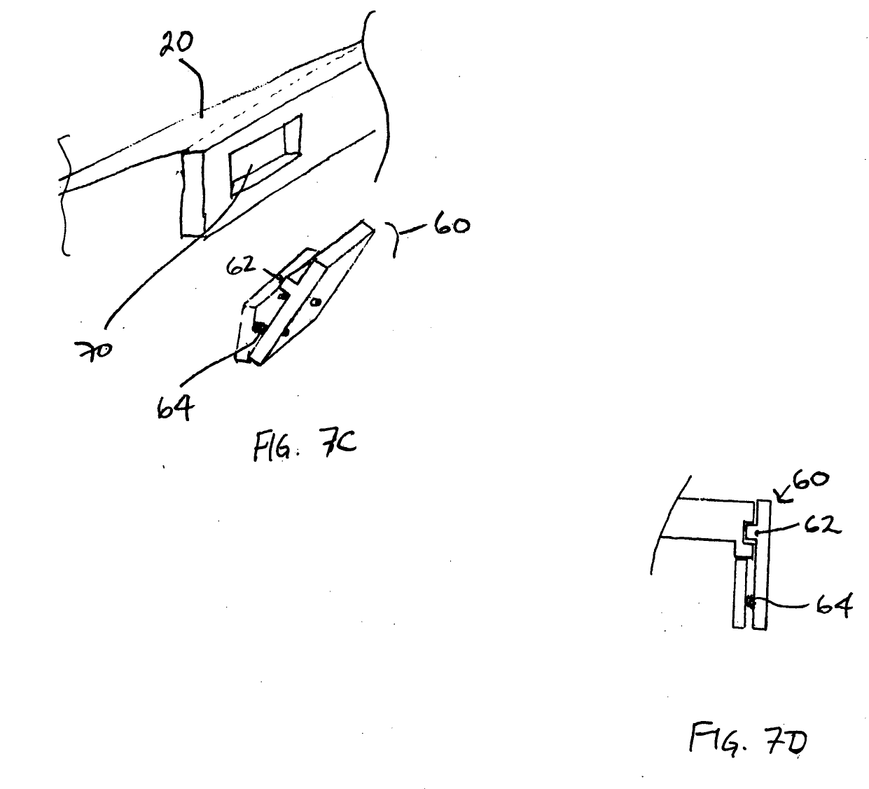

FIGS. 7A and 7B illustrate an alternative embodiment of clip 60. In this embodiment, clip 60 is comprised of a hinged base 61 having a protrusion 62. FIGS. 7A and 7B show the protrusion as rectangular in shape, although it is understood that the protrusion may have alternate shapes such as square, trapezoidal or triangular. The hinged base 61 of the clip 60 is coupled to the lower housing 10 via a pair of reverse tension compression springs 64. If force is applied to the tip of the clip 60, the hinged base extends outward, away from the lower housing 10 and the tension in the pair of reverse tension compression springs increases.

Therefore, in this alternate embodiment, and as shown in FIGS. 7C and 7D, clip 60 may be displaced by the application of a normal force, as applied by a finger or thumb of the grill user, thereby expanding the reverse tension compression springs and moving the clip outward. This allows for juxtaposition of catch 70 against clip 60 such that protrusion 62 is positioned for entry into catch 70. Subsequent removal of the normal force causes the reverse tension springs to pull the clip 60 back to its default position such that protrusion 62 is then secured within catch 70, as shown in FIG. 7D. In the preferred embodiment, the length of lower cooking plate 20 that lies between clasps 50 and catches 70 is precisely long enough such that when protrusions 62 are secured within catches 70, the lower cooking plate is secured to the lower housing and there is no unwanted shifting of lower cooking plate 20 during cooking.

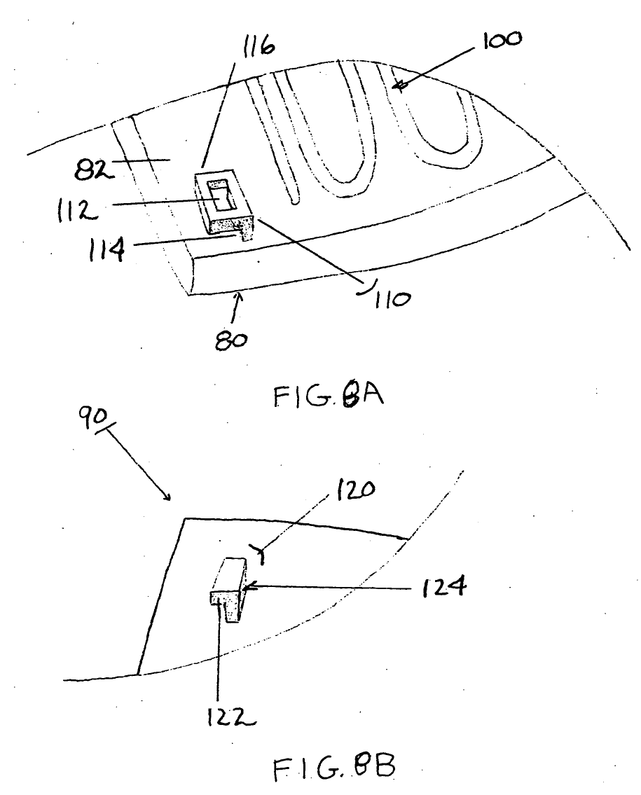

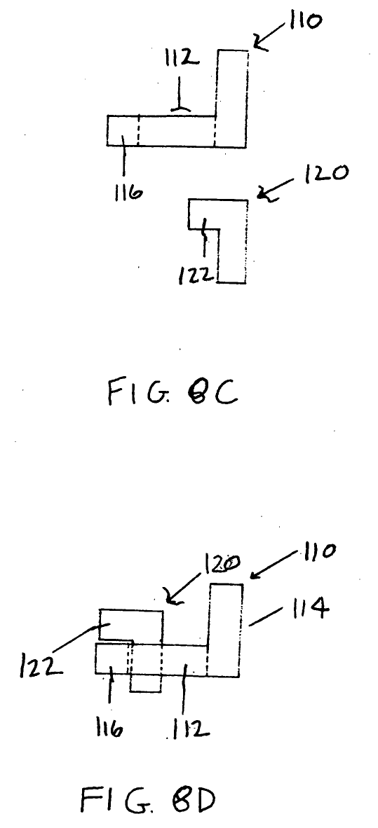

Similarly, the facilitated removal and replacement of upper cooking plate 90 is enabled by a catch/clasp and clip/catch arrangement. FIG. 8A is a fragmentary perspective view of one of the corners of upper housing 80 proximate to connecting unit 75. In the preferred embodiment, catch 110 is identical to catch 40 except for its placement in the upper housing as opposed to the lower housing. Referring to FIG. 8A, catch 110 includes aperture 112 and base 114. Catch 110 is coupled to the upper housing 80 by base 114. Catch 110 may be comprised of a number of different metals or practical equivalents, including steel, iron, copper, brass, or any combination thereof.

FIG. 8B is a fragmentary perspective view of one of the corners of the upper cooking plate 90 proximate to connecting unit 75. Referring to FIG. 8B relative to FIG. 3, upper cooking plate 90 has been flipped such that clasp 120 is coupled to the non-cooking or bottom surface of upper cooking plate 90 (i.e.: the side of upper cooking plate 90 that does not come in contact with food during cooking). In the preferred embodiment, clasp 120 is identical to clasp 50 except for its placement on upper cooking plate 90 as opposed to the lower cooking plate 20. Referring to FIG. 8B, clasp 120 includes a base 124 and a protrusion 122 and is coupled to the non-cooking or bottom surface of upper cooking plate 90 by base 124. Catch 120 may be comprised of a number of different metals or practical equivalents, including steel, copper, brass, or any combination thereof.

FIG. 8C is a cross-sectional view of clasp 120 juxtaposed beneath catch 100. Referring to FIG. 8C, when the upper cooking plate is coupled to the upper housing, catch 110 accepts clasp 120 through aperture 112 such that protrusion 122 is secured above border 116. FIG. 8D is a cross-sectional view of clasp 120 secured within catch 110.

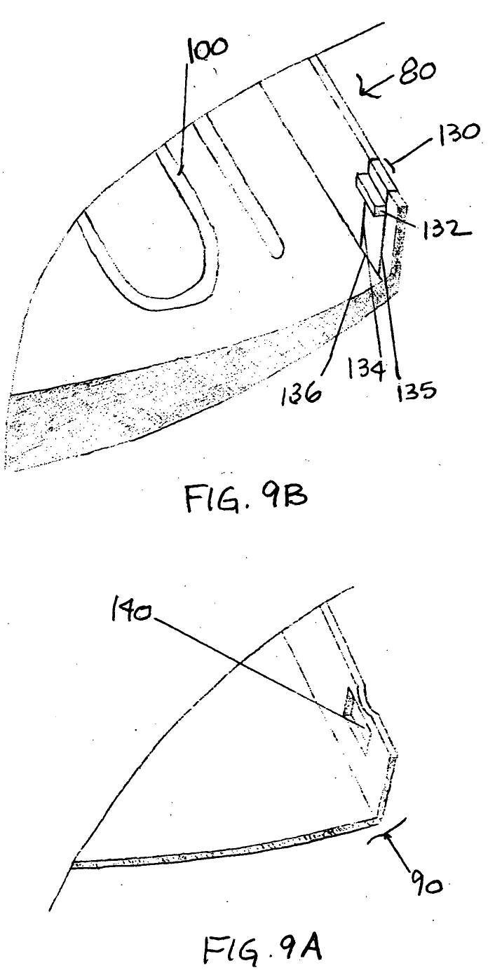

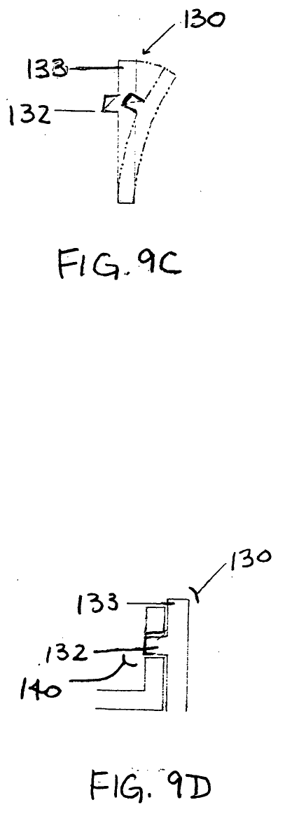

FIG. 9A is a fragmentary perspective view of one of the corners of upper housing 80 distal to connecting unit 75. Referring to FIG. 9A, upper housing 80 include a clip 130 having a bottom 136 and a protrusion 132. The bottom 136 of clip 130 is continuous with the outer shell of upper housing 80 but separated vertically from the outer shell of upper housing 80 at separation 134 and separation 135 such that said clip 130 is not integrally formed as part of said upper housing 80. Clip 130 may be comprised of plastic or other materials possessing a high elastic limit or yield point, as those terms “elastic limit” and “yield point” are commonly known among those skilled in the art.

FIG. 9B is a fragmentary perspective view of one of the corners of upper cooking plate 90 distal to connecting unit 75. Referring to FIG. 9B relative to FIG. 3, upper cooking plate 90 has been flipped such that the non-cooking bottom side of upper cooking plate 20 (i.e.: the side of lower cooking plate 20 that does not come in contact with food during cooking) is shown. As shown, the bottom side of the upper cooking plate includes a lipped edge having at least one catch 140 position distal to the connecting unit 75 Referring to FIG. 9B, catch 140 is comprised of an aperture for reception of protrusion 132.

FIG. 9C is a cross-sectional view of clip 130 of the upper housing. As shown in FIG. 9C, clip 130 may be displaced by the application of a normal force at 133, as applied by a finger or thumb of the grill user, allowing juxtaposition of catch 140 against clip 130 such that protrusion 132 is positioned for entry into catch 140 when the upper cooking plate is coupled to the upper housing. Subsequent removal of the normal force at 133 allows clip 130 to snap back to its default position such that protrusion 132 is secured within catch 140, as shown in FIG. 9D. In the preferred embodiment, the length of upper cooking plate 90 that lies between clasps 120 and catches 140 is precisely long enough such that when protrusions 132 are secured within catches 140, the upper cooking plate is secured to the upper housing and there is no unwanted shifting of upper cooking plate 90 during cooking.

Referring again to FIG. 3, lower cooking plate 20 is attached to lower housing 10 by first lowering the end of lower cooking plate 20 distal to connecting unit 75 such that clasps 50 located on the non-cooking or bottom surface of lower housing 10 are secured within catches 40 located within the lower housing, as shown in FIGS. 5C-5D. Once clasps 50 are secured in catches 40, clips 60 of the lower housing 10 are displaced by the application of normal forces at 63, as shown in FIG. 6C. Referring to FIGS. 6A-6D, as the normal force is applies to clip 60, the end of lower cooking plate 20 proximate to connecting unit 75 is lowered toward the lower housing 10 such that the catches 70 in the lipped edge 23 are placed into position in order to receive protrusions 62 of clips 60 of the lower housing 10. The normal forces at 63 are then released such that protrusions 62 are secured within catches 70, as shown in FIG. 6D, thus securing the lower cooking plate 20 to the lower housing 10.

Referring again to FIG. 3, upper cooking plate 90 is attached to the upper housing 80 by first lowering the end of upper cooking plate 90 proximate to connecting unit 75 such that clasps 120 located on the non-cooking bottom side of the upper cooking plate 90 are secured within catches 110 located within the upper housing 90, as shown in FIGS. 8C-8D. Once clasps 120 are secured in catches 110, clips 130 of the upper housing 80 are displaced by the application of normal forces at 133, as shown in FIG. 9C. Referring to FIGS. 9A-D, while the normal force is applied to clips 130 of the upper housing 80, the end of upper cooking plate 90 distal to connecting unit 75 is juxtaposed against upper housing 80 such that catches 140 of the upper cooking plate 90 are in position to receive protrusions 132 of clips 130. The normal forces at 133 are then released such that protrusions 132 are secured within catches 140, as shown in FIG. 9D, thus securing the upper cooking plate to the upper housing.

As explained earlier one of the objects of the invention is to allow for the easy removal of the upper and lower cooking plates for cleaning or replacement. Therefore, after cooking, and referring to FIGS. 9C-9D, upper cooking plate 90 may be easily removed from upper housing 80 by reapplying normal forces at 133 and pulling the end of upper cooking plate 90 distal to connecting unit 75 away from upper housing 80. As normal forces are applied to clip 130 of the upper housing, the protrusion is released from catch 140, thereby allowing the grill user to pull the end of upper cooking plate 90 distal to the connecting unit 75 outward and away from the upper housing 80. Once the end of upper cooking plate 90 distal to connecting unit 75 has been freed from the clips 130 of upper housing 80, the upper cooking plate 90 is free to shift in a direction away from connecting unit 75 and may be lifted away from the upper housing 80 such that clasps 120 on the non-cooking bottom surface of the upper cooking plate 90 may be easily removed from catches 110 of the upper housing 80, thereby releasing upper cooking plate 90 from upper housing 80.

Similarly, referring to FIGS. 6A-6D, lower cooking plate 20 may be easily removed from lower housing 10 by reapplying normal forces to clip 60 of the lower housing 10 and lifting the end of lower cooking plate 20 proximate to connecting unit 75 up and away from the lower housing. As normal forces are applied to clip 60 of the lower housing, protrusion 62 is released from catch 70 in the lipped edge of the lower cooking plate 20, thereby allowing the grill user to pull the end of lower cooking plate 20 proximate to the connecting unit 75 upward and away from the lower housing 10. Once the end of lower cooking plate 20 proximate to connecting unit 75 has been so displaced, lower cooking plate 20 is free to shift in a direction toward connecting unit 75 such that clasps 50 on the non-cooking bottom side of the lower cooking plate may be easily removed from catches 40 of the lower housing, thereby releasing lower cooking plate 20 from lower housing 10.

Once removed, upper cooking plate 90 and lower cooking plate 20 may be easily washed under a faucet, soaked in a sink, or placed in a dishwasher. Additionally, the upper cooking plate and lower cooking plate maybe each be easily removed and replaced with cooking plates possessing alternative cooking surfaces that are more useful for cooking particular types of foods. For example, the cooking plates illustrated in the all the diagrams are shown to have “ribs”. As explained earlier, formation of ribs allows for easier and more efficient cooking of foods like meats or vegetables because the channels between the ribs can carry away grease and fats that drain from meats while cooking. Alternatively, upper and lower cooking plates may be used which have flat cooking surfaces. Use of flat griddle-like cooking surfaces are useful for cooking foods such as potatoes or pancakes.

Thus, the invention describes an electric countertop contact grill device with easily removable cooking plates. The user may more easily clean the cooking plates by removing them and washing them under a faucet, soaking them in a sink, or placing them in a dishwasher. The user may also easily vary the cooking surfaces by replacing the cooking plates with other cooking plates possessing alternative cooking surfaces that are more useful for cooking particular types of foods.

While the description above contains many specifics, these should not be construed as limitations on the scope of the invention, but rather as exemplifications of particular embodiments thereof. One of ordinary skill in the art may made many changes, modifications, and substitutions without necessarily departing from the spirit and scope of the invention. For example, in another embodiment of the invention, no heating element is disposed within the upper housing for supplying heat to the upper cooking plate to provide heat to the cooking chamber. In another embodiment of the invention, the upper housing defines a compartment with a vented lid adapted to hold at least one bun in order to warm the bun with heat derived from the cooking chamber. In yet another embodiment of the invention, the cooking chamber contains a seasoning supply vessel adapted to receive a body of seasonings in liquid form, and a thermal conductive dispenser extendible into the vessel when the grill is in a closed position and that when heated releases a stream of seasonings continuously from the seasoning supply vessel into the cooking chamber via vaporization. Accordingly, the scope of the invention should be determined not by the embodiments described above, but by the appended claims and their legal equivalents.

What is claimed is:

1. An electrically operated countertop, contact grill for cooking foodstuffs, said grill comprising:
a lower housing having at least one heating element disposed therein;
a removable lower cooking plate coupled to said lower housing and having an upwardly facing cooking surface;
an upper housing pivotally coupled to said lower housing and having at least one heating element disposed therein; and
a removable upper cooking plate coupled to said upper housing and having a downwardly facing cooking surface.

2. The electrically operated countertop, contact grill of claim 1, wherein the lower housing has a downwardly sloping surface such that when the removable lower cooking plate is coupled to the lower housing, the upwardly facing cooking surface of the removable lower cooking plate slopes downward and away from a proximal location near the pivot axis to a distal location that is considered to be at the front of the grill.

3. The electrically operated countertop, contact grill of claim 1 wherein:
the upwardly facing cooking surface of the removable lower cooking plate is “ribbed”; and
the downwardly facing cooking surface of the removable upper cooking plate is “ribbed”.

4. The electrically operated countertop, contact grill of claim 1 further comprising:
at least one catch coupled within said lower housing at a distal end of said lower housing and at least one clip coupled to a proximate end of said lower housing;
at least one clasp coupled to a non-cooking bottom surface at a distal end of said removable lower cooking plate and at least one catch disposed within a proximate end of said removable lower cooking plate;
wherein the at least one clasp of the removable lower cooking plate is engaged with the at least one catch of the lower housing and the at least one catch of removable lower cooking plate is engaged with the at least one clip of the lower housing, thereby securely coupling the removable lower cooking plate to the lower housing.

5. The electrically operated countertop, contact grill of claim 1 further comprising:
at least one catch coupled within said upper housing at a proximate end of said upper housing and at least one clip coupled to a distal end of said upper housing;
at least one clasp coupled to a non-cooking bottom surface at a proximate end of said removable upper cooking plate and at least one catch disposed within a distal end of said removable upper cooking plate;
wherein the at least one clasp of the removable upper cooking plate is engaged with the at least one catch of the upper housing and the at least one catch of the removable upper cooking plate is engaged with the at least one clip of the upper housing, thereby securely coupling the removable upper cooking plate to the upper housing.

6. A device for cooking foodstuffs comprising:
a lower housing defining a horizontal plane, and having a removable lower cooking plate coupled thereto and disposed at an angle relative to the horizontal plane;
an upper housing having a removable upper cooking plate coupled thereto, said upper housing being pivotally coupled to said lower housing thereby defining a pivot axis and allowing the upper cooking plate to be movable relative to said lower cooking plate to a closed position to form with said lower cooking plate a cooking chamber for cooking foodstuffs;
at least one heating element disposed within said lower housing for supplying heat to said lower cooking plate; and
at least one heating element disposed within said upper housing for supplying heat to said upper cooking plate.

7. The device of claim 6 wherein the lower cooking plate inclines gradually and downwardly from a proximate position relative to said pivot axis toward a distal position relative to said pivot axis such that liquid byproducts emitted by said foodstuffs during cooking within said cooking chamber flow downwardly on the lower cooking plate toward a liquid byproducts collection reservoir disposed at said distal position.

8. The device of claim 6 wherein the removable lower cooking plate is coupled to the lower housing using a holding means comprised off:
one or more clips disposed on the end of said lower housing proximate to said pivot axis;
one or more catches disposed within the end of said lower housing distal to said pivot axis;
one or more catches disposed within the end of said removable lower cooking plate proximate to said pivot axis;
one or more clasps disposed on the end of said removable lower cooking plate distal to said pivot axis; and
wherein the one or more clasps of the removable lower cooking plate is engaged with the one or more catches of the lower housing and the one or more catches of the removable lower cooking plate is engaged with the one or more clips of the lower housing, thereby securely coupling the removable lower cooking plate to the lower housing.

9. The device of claim 8 wherein said one or more clips of said lower housing number two, said one or more catches of said lower housing number two, said one or more catches of said lower cooking plate number two, said one or more clasps of said lower cooking plate number two.

10. The device of claim 6 wherein the removable upper cooking plate is coupled to the upper housing using a holding means comprised of:
one or more clips disposed on the end of said upper housing distal to said pivot axis;
one or more catches disposed on end of said upper housing proximate to said pivot axis;
one or more catches disposed on the end of said upper cooking plate distal to said pivot axis;
one or more clasps disposed on the end of said upper cooking plate proximate to said pivot axis; and
wherein the one or more clasps of the removable upper cooking plate is engaged with the one or more catches of the upper housing and the one or more catches of the removable upper cooking plate is engaged with the one or more clips of the upper housing, thereby securely coupling the removable upper cooking plate to the upper housing.

11. The device of claim 10 wherein said one or more clips of said upper housing number two, said one or more catches of said upper housing number two, said one or more catches of said upper cooking plate number two, and said one or more clasps of said upper cooking plate number two.

12. The device of claim 6 wherein said removable upper and lower cooking plates each bear a flat cooking surface.

13. The device of claim 6 wherein said removable upper and lower cooking plates each bear a ribbed cooking surface having vertical ribs which more closely approximates an outdoor meat grilling or barbeque arrangement, and wherein channels between the ribs can carry away grease and fats that drain from meats while cooking

14. The device of claim 13 wherein said lower cooking plate includes at least one opening therein at approximately its lowest point, whereby liquid byproducts emitted by foodstuffs during cooking within said cooking chamber are directed to and through said at least one opening in said lower cooking plate, said device further having a liquid byproduct collection tray positioned beneath the at least one opening in said lower cooking plate for collecting at least a portion of the liquid byproducts passing through the at least one opening in said lower cooking plate.

15. The device of claim 14 wherein the liquid byproduct collection tray is separable from and replaceable with respect to said first cooking plate for removing from said device liquid byproducts collected in said liquid byproducts collection tray.

16. The device of claim 15 wherein the liquid byproducts collection tray is accessible at the front of the device for removal therefrom.

17. A pair of removable grilling plates for use in an electrical countertop contact grill, comprising:
a lower grilling plate having a grilling surface and a non-grilling surface and further including a means for removably coupling said lower grilling plate to a lower housing of said electrical countertop contact grill; and
an upper grilling plate having a grilling surface and a non-grilling surface and further including a means for removably coupling said upper grilling plate to an upper housing of said electrical countertop contact grill.

18. The pair of removable grilling plates of claim 17, wherein the means for removably coupling said lower grilling plate to the lower housing of said contact grill is comprised of:
at least one catch coupled within said lower housing at a distal end of said lower housing and at least one clip coupled to a proximate end of said lower housing;
at least one clasp coupled to the non-grilling surface at a distal end of said removable lower cooking plate and at least one catch disposed within a proximate end of said removable lower cooking plate;
wherein the at least one clasp of the removable lower cooking plate is engaged with the at least one catch of the lower housing and the at least one catch of removable lower cooking plate is engaged with the at least one clip of the lower housing, thereby securely, yet removably, coupling the removable lower cooking plate to the lower housing.

19. The pair of removable grilling plates of claim 17, wherein the means for removably coupling said upper grilling plate to the upper housing of said contact grill is comprised of:
at least one catch coupled within said upper housing at a proximate end of said upper housing and at least one clip coupled to a distal end of said upper housing;
at least one clasp coupled to the non-grillling surface at a proximate end of said removable upper cooking plate and at least one catch disposed within a distal end of said removable upper cooking plate;
wherein the at least one clasp of the removable upper cooking plate is engaged with the at least one catch of the upper housing and the at least one catch of the removable upper cooking plate is engaged with the at least one clip of the upper housing, thereby securely, yet removably, coupling the removable upper cooking plate to the upper housing.

20. The pair of removable grilling plates of claim 17, wherein:
the grilling surface of the removable lower cooking plate is “ribbed”; and
the grilling surface of the removable upper cooking plate is “ribbed”.

21. The pair of removable grilling plates of claim 20, wherein said lower cooking plate includes at least one opening therein and whereby liquid byproducts emitted by foodstuffs during cooking within said cooking chamber are directed to and through said at least one opening in said lower cooking plate.

22. An electrically operated countertop grill for cooking foodstuffs comprising:
a lower housing defining a horizontal plane, and having a lower cooking plate disposed at an angle relative to the horizontal plane;
an upper housing having an upper cooking plate disposed therein, said upper cooking plate being movable about a pivot axis relative to said lower cooking plate to a closed position to form with said lower cooking plate a cooking chamber for cooking foodstuffs which substantially restrains the escape of vapor therefrom;
at least one heating element disposed within said lower housing for supplying heat to said lower cooking plate to provide heat to said cooking chamber;
at least one heating element disposed within said upper housing for supplying heat to said upper cooking plate to provide heat to said cooking chamber;
said lower cooking plate inclining gradually and downwardly from a proximate position relative to said pivot axis toward a distal position relative to said pivot axis such that liquid byproducts emitted by said foodstuffs during cooking within said cooking chamber flow downwardly on the lower cooking plate toward a liquid byproducts collection reservoir disposed at said distal position; and
a clasp and clip system for holding said cooking plates to said housings further comprising;
i. one or more clips disposed on the end of said lower housing proximate to said pivot axis;
ii. one or more catches disposed on end of said lower housing distal to said pivot axis;
iii. one or more catches disposed on the end of said lower cooking plate proximate to said pivot axis;
iv. one or more clasps disposed on the end of said lower cooking plate distal to said pivot axis;
v. one or more clips disposed on the end of said upper housing distal to said pivot axis;
vi. one or more catches disposed on end of said upper housing proximate to said pivot axis;
vii. one or more catches disposed on the end of said upper cooking plate distal to said pivot axis;
viii. one or more clasps disposed on the end of said upper cooking plate proximate to said pivot axis;
ix. wherein said lower cooking plate when fastened to said lower housing is fastened to said lower housing by said one or more clips and said one or more catches of said lower housing, and said upper cooking plate when fastened to said upper housing is fastened to said upper housing by said one or more clips and said one or more catches of said upper housing.

23. The electrically operated countertop grill of claim 22 wherein said one or more clips of said lower housing number two, said one or more catches of said lower housing number two, said one or more catches of said lower cooking plate number two, said one or more clasps of said lower cooking plate number two.

24. The electrically operated countertop grill of claim 22 wherein said one or more clips of said upper housing number two, said one or more catches of said upper housing number two, said one or more catches of said upper cooking plate number two, and said one or more clasps of said upper cooking plate number two.
